(19) United States
(12) Patent Application Publication
(10) Pub. No.: US 2025/0293460 A1
(43) Pub. Date: Sep. 18, 2025

(54) CONNECTOR

(71) Applicant: BIZLINK INTERNATIONAL CORP., New Taipei City (TW)

(72) Inventor: Chin-An HSIEH, New Taipei City (TW)

(21) Appl. No.: 18/607,605

(22) Filed: Mar. 18, 2024

(51) Int. Cl. H01R 13/627; H01R 12/75; H01R 13/633

(52) U.S. Cl. CPC H01R 13/6273; H01R 13/6335; H01R 12/75

(57) ABSTRACT

A connector includes a base, two barriers, and a latch. The base includes a front surface, an upper surface, and two side surfaces. The barriers are connected to the upper surface. Each barrier has a first stopping surface perpendicular to the upper surface. The latch includes a pull handle connecting with two snapping plates via two connecting arms respectively. Each snapping plate covers a portion of the two side surfaces. A portion of the connecting arms is located on the upper surface. One of the snapping plates has a first hook protruding away from the base. When pull handle is pulled away from the base along a pulling direction, the latch switches from an unlocking state to a locking state. Meanwhile, each connecting arm is moved and abuts against the stopping surface and control movement of the first hook via the one of the snapping plates.

### BACKGROUND

### Technical Field

The present disclosure relates to a connector, and more particularly, to a wire-end connector.

### Description of Related Art

Wire-end connectors can be inserted into server machines, board-end connectors, and other devices for signal transmission. Common wire-end connectors on the market often include fasteners. The fasteners are mostly used to fix the wire-end connectors when the connectors are inserted and connected, so that the wire-end connectors will not fall off and cause abnormal signal transmission.

However, existing fasteners often have problems such as long insertion and extraction strokes and difficulty in operation. The housing designs of some wire-end connectors are also limited by the fasteners. For example, a connector uses its housing to compress the fasteners to cause them to pop out or retract, which results in the design of the housing needing to match the actuation stroke of the fastener, and thus limits the assembly direction of the housing to only be perpendicular to the actuation direction of the fastener. In other words, the technical problem of “inconvenient housing design” arises.

Accordingly, how to provide a connector to solve the aforementioned problems becomes an important issue to be solved by those in the industry.

### SUMMARY

An aspect of the disclosure is to provide a connector that can efficiently solve the aforementioned problems.

According to an embodiment of the disclosure, a connector includes a base, two barriers, and a latch. The base includes a front surface, an upper surface, and two side surfaces. The barriers are connected to the upper surface. Each of the barriers has a first stopping surface perpendicular to the upper surface. The latch includes a pull handle connecting with two snapping plates via two connecting arms respectively. Each of the snapping plates covers at least a portion of the two side surfaces of the base respectively. Both of the snapping plates are substantially perpendicular to the connecting arms respectively. At least a portion of the connecting arms is located on the upper surface. At least one of the snapping plates has a first hook protruding away from the base. When the pull handle of the latch is pulled away from the base along a pulling direction, the latch switches from an unlocking state to a locking state. Meanwhile, each of the connecting arms is moved and abuts against the stopping surface and control movement of the first hook via the at least one of the snapping plates.

In an embodiment of the disclosure, when the latch switches from an unlocking state to a locking state, each of the connecting arms is deformed and abuts against the stopping surface.

In an embodiment of the disclosure, both of the barriers are located on an edge of the front surface of the base and define a tunnel therebetween. Both of the connecting arms extend away from the base via the tunnel.

In an embodiment of the disclosure, both of the connecting arms extend away from the base along the pulling direction via a tunnel formed between the two barriers.

In an embodiment of the disclosure, each of the side surfaces of the base has a second stopping surface. When the latch is in a locked state, majority portions of the two snapping plates are separated from the two second stopping surfaces. When the connecting arms are at the unlocked state, the majority portions the two snapping plates respectively abut against the two second stopping surfaces.

In an embodiment of the disclosure, the two second stopping surfaces are inclined surfaces. A distance between the two second stopping surfaces gradually changes in the pulling direction.

In an embodiment of the disclosure, the base further includes a rear surface connected to the upper surface. The barrier is located on a side of the upper surface close to the rear surface. The first stopping surface is an inclined surface. The inclined surface gradually extends toward the rear surface along a direction away from the two snapping plates.

In an embodiment of the disclosure, the one of the two snapping plates has a proximal end portion and a distal end portion. The first hook is connected to the distal end portion. When the latch switches from the a locked state to the unlocked state, at least one of the two snapping plates rotates relative to the base with the proximal end portion as a fulcrum, so that the first hook is moved closer to the base.

In an embodiment of the disclosure, the base further includes a bottom surface opposite to the upper surface. The latch further includes a second hook. The second hook is connected to at least one of the two snapping plates. The second hook is engaged with a recess on the bottom surface for preventing the latch from separating from the base.

In an embodiment of the disclosure, each of the connecting arms has a notch along an outer edge thereof.

In an embodiment of the disclosure, the connecting arms and the snapping plates are one piece formed.

In an embodiment of the disclosure, the base has an inserting section and a latching section. All of the upper surface and the two side surfaces of the base are on a rear section side.

According to an embodiment of the disclosure, a connector includes a base, at least one bump, a plugging terminal, a cable, and a latch. The base includes an upper surface and two positioning grooves. The two positioning grooves are respectively connected to opposite sides of the upper surface. The barrier is connected to the upper surface. The barrier has a first stopping surface. The plugging terminal is connected to the base. The cable is electrically connected to the plugging terminal in the base. The latch includes a pull handle, two connecting straps, and two snapping plates. The two snapping plates are connected to the base and respectively disposed in the two positioning grooves. The two connecting straps are respectively connected to the two snapping plates. At least one of the two connecting straps faces the first stopping surface. The latch is configured to be located at a locked state and an unlocked state relative to the base. When the latch is at the locked state, a gap between the two connecting straps has a first distance. When the latch is at the unlocked state, the gap has a second distance. The first distance is greater than the second distance.

In an embodiment of the disclosure, one of the two connecting straps has a notch. The notch is located on a side of the one of the two connecting straps away from another of the two connecting straps.

In an embodiment of the disclosure, each of the two connecting straps has an arc edge. The arc edges are located on adjacent sides of the two connecting straps.

In an embodiment of the disclosure, a number of the at least one barrier is two. The two barriers respectively include two first stopping surfaces. The two first stopping surfaces are located on a side of the barriers away from the pull handle and configured to be abutted by the connecting straps.

In an embodiment of the disclosure, a distance between the two first stopping surfaces gradually decreases along a direction toward the pull handle.

Accordingly, since the connector of the present disclosure includes the barrier and the latch, the snapping plates can be easily pulled. In addition, the design of the present disclosure only requires putting the latch on the molding piece, which has the advantages of simple design, low cost, and freedom of design.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view of a connector and a frame according to an embodiment of the present disclosure;

FIG. 2 is an exploded view of the connector and the frame in FIG. 1;

FIG. 3 is a side view of the connector according to an embodiment of the present disclosure;

FIG. 4 is a perspective view of the frame according to an embodiment of the present disclosure;

FIG. 5 is a top view of the connector and the frame according to an embodiment of the present disclosure;

FIG. 6 is a cross-sectional view of the connector and the frame in FIG. 5;

FIG. 7 is a side view of the connector, the frame, and a printed circuit board according to an embodiment of the present disclosure;

FIG. 8 is a side view of the connector, the frame, and the printed circuit board according to an embodiment of the present disclosure;

FIG. 9 is a top view of the connector and the frame at an unlocked state according to an embodiment of the present disclosure;

FIG. 10 is a top view of a molding piece according to an embodiment of the present disclosure;

FIG. 11 is a bottom perspective view of the connector and the frame at the unlocked state according to an embodiment of the present disclosure; and

FIG. 12 is a partial enlarged view of the connector and the frame in FIG. 11.

### DETAILED DESCRIPTION

The following disclosure will now be described more fully herein by drawings and references, in which some exemplary embodiments are shown. The present disclosure may be implemented in different forms and should not be limited by the embodiments mentioned below. However, these embodiments are provided to facilitate a more complete understanding of the disclosure and to fully convey the scope of the disclosure to those skilled in the art. The same reference numbers will be used throughout the text to refer to similar elements.

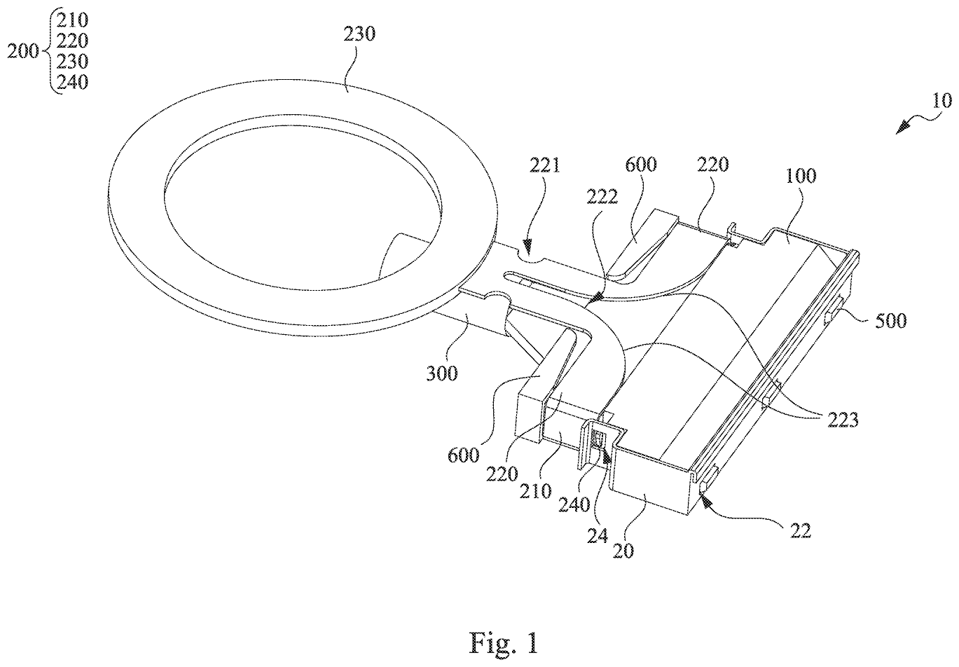

In addition, FIGS. 1 to 10 are drawn to true scale. In order to keep the description concise, the proportions of each component are not listed one by one. However, the proportions and positions of each component shall be regarded as part of the contents of the present disclosure.

As shown in FIGS. 1 to 10, the present disclosure provides a plurality of embodiments of connectors and electrical connection modules, which can be applied to, for example, the server connection field.

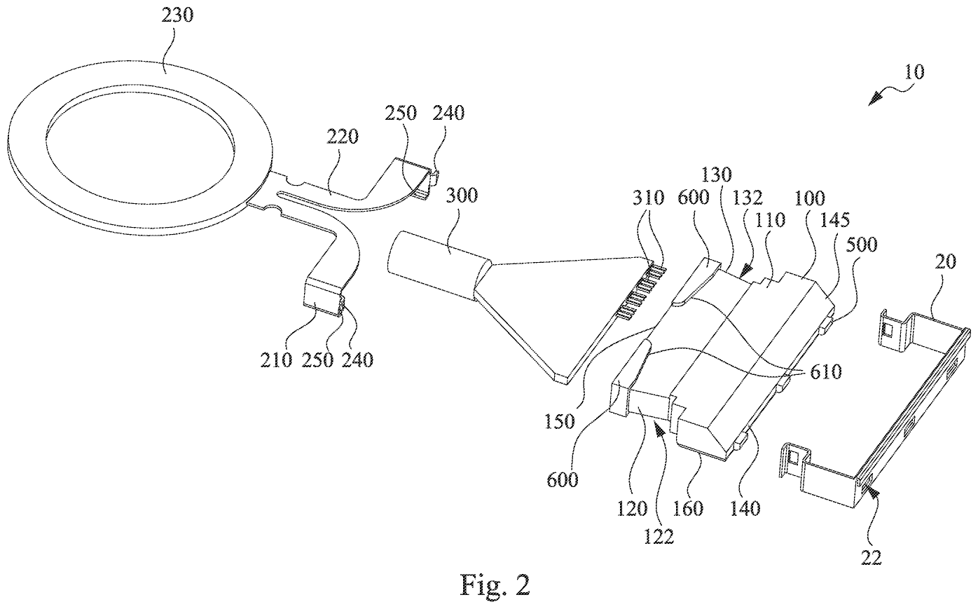

Reference is made to FIGS. 1, 2, and 3. FIG. 1 is a perspective view of a connector 10 and a frame 20 according to an embodiment of the present disclosure. FIG. 2 is an exploded view of the connector 10 and the frame 20 in

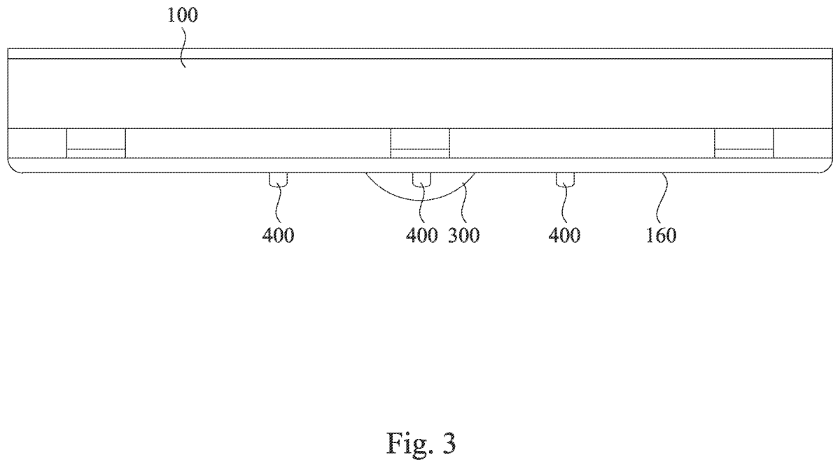

FIG. 1. FIG. 3 is a side view of the connector 10 according to an embodiment of the present disclosure. In the present embodiment, the connector 10 includes a molding piece 100, a latch 200, a cable 300, a plurality of terminals 400 (referred to FIG. 3), protruding portions 500, and barriers 600.

The molding piece 100 is connected to the latch 200.

The molding piece 100 includes an upper surface 110, side surfaces 120, 130, a front surface 140, a guiding inclined surface 145, a rear surface 150, and a bottom surface 160. The side surfaces 120, 130 are respectively connected to opposite sides of the upper surface 110. The side surfaces 120, 130 respectively have positioning grooves 122, 132. The upper surface 110 and the bottom surface 160 are respectively located on opposite sides of the molding piece 100. The guiding inclined surface 145 is connected to the upper surface 110 and the front surface 140.

The latch 200 includes snapping plates 210, connecting straps 220, a pull handle 230, first hooks 240, and second hooks 250. The number of the snapping plates 210 is two. The two snapping plates 210 are connected to the molding piece 100. The two snapping plates 210 are respectively disposed in the positioning grooves 122, 132. In other words, the two snapping plates 210 are respectively disposed on the side surfaces 120, 130. The number of the connecting straps 220 is two. The two connecting straps 220 are respectively connected to the two snapping plates 210. The connecting straps 220 are above the upper surface 110. The pull handle 230 is connected to the connecting straps 220. The connecting straps 220 are configured to move back and forth relative to the molding piece 100 along the upper surface 110 (by force exerted on the pull handle 230). The first hooks 240 are connected to the snapping plates 210. The first hooks 240 extend from an end of the snapping plates 210 away from the pull handle 230 in a direction away from the molding piece 100. The second hooks 250 are connected to the snapping plates 210. The second hooks 250 are engaged with the bottom surface 160 of the molding piece 100, so as to fix the latch 200 to the molding piece 100. An end of the cable 300 is disposed on the molding piece 100, and another end of the cable 300 extends away from the molding piece 100 from the rear surface 150 of the molding piece 100. The cable 300 includes a plurality pairs of signal wires. The plug terminals 400 are connected to the molding piece 100. The plug terminals 400 are electrically connected to the signal wires in the molding piece 100. The protruding portions 500 are disposed on the front surface 140. The protruding portions 500 protrude along a direction away from the molding piece 100. The barriers 600 are connected to the upper surface 110. The barriers 600 are located on a side of the molding piece 100 close to the rear surface 150. The barriers 600 and the protruding portions 500 are respectively located on opposite sides of the molding piece 100. The barriers 600 are configured to abut against and limit the connecting straps 220. In the present embodiment, the protruding portions 500 and the barriers 600 are all one piece formed with the molding piece 100 as a part thereof. Alternatively, either the protruding portions 500 or the barriers 600 can be independent components that are secured onto the surface of the molding piece 100.

As shown in FIG. 1, in some embodiments, the barrier 600 form a part of the positioning groove 122 or the positioning groove 132. In some embodiments, the number of the barriers 600 is two and the barriers 600 respectively correspond to the two connecting straps 220.

In some embodiments, the two connecting straps 220 may be collectively referred to as a connecting arm. The connecting arm has a gap 222 that separates the two connecting straps 220. The gap 222 can make the latch 200 more evenly stressed and less likely to break. In some alternative embodiments, the connecting arm does not have the gap 222, so that the connected two connecting straps 220 can be T-shaped when viewed from a top view.

As shown in FIG. 1, in some embodiments, any of the two connecting straps 220 may include a notch 221. The notch 221 is located on a side of the one of the two connecting straps 220 away from another of the two connecting straps 220.

As shown in FIG. 1, in some embodiments, each of the two connecting straps 220 has an arc edge 223. The two arc edges 223 are located on adjacent sides of the two connecting straps 220. The arc edges 223 can provide buffering when the connecting straps 220 are stressed, which makes the connecting straps 220 less likely to break.

As shown in FIG. 3, in some embodiments, the plug terminals 400 retractably protrude from the bottom surface 160 of the molding piece 100. The plug terminals 400 are configured to be connected to a printed circuit board to transmit signals. In some embodiments, each of the plug terminals 400 may be a retractable bar formed of high conductivity material, for example, copper, with a spring-liked or zigzag shaped base (not shown) embedded into the molding piece 100 and secured therewith, in which the base has a flat-shaped connecting arm capable of allowing cable to be soldered thereon.

Alternatively, each of the plug terminals 400 may be a pogo pin like elements. It should be noted that although in the embodiment provided herein, the plug terminals 400 protrude from the bottom surface 160, in practice, the plug terminals 400 may be disposed at any suitable position on the molding piece 100, such as on the front surface 140 or others.

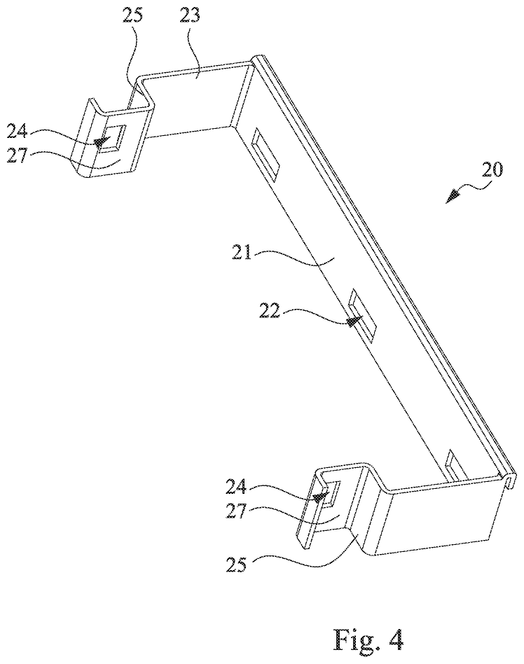

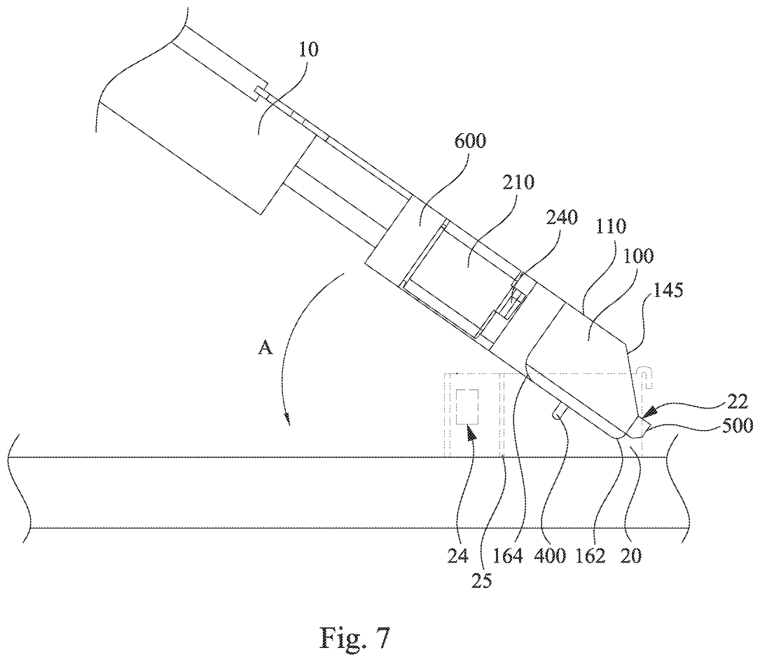

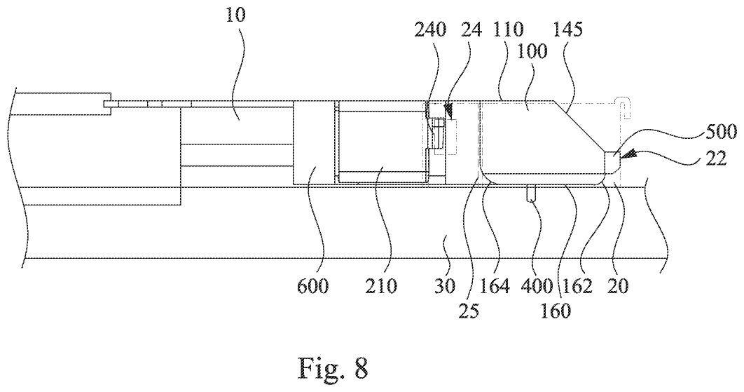

Reference is made to FIG. 1 and FIG. 4. FIG. 4 is a perspective view of the frame 20 according to an embodiment of the present disclosure. In the present embodiments, the frame 20 is configured to be secured on the printed circuit board (e.g., on the printed circuit board 30 in FIGS. 7 and 8), so that the plug terminals 400 of the connector 10 can be more accurately aligned and connected to the printed circuit board.

The frame 20 includes a stopping wall 21, first slot 22, connecting walls 23, second slots 24, protruding ribs 25, and side walls 27. The first slots 22 are disposed on the stopping wall 21. Two ends of each of the connecting walls 23 are respectively connected to the stopping wall 21 and a corresponding one of the protruding ribs 25. The stopping wall 21 is parallel to the protruding ribs 25. The second slots 24 are disposed on the side walls 27. The first slots 22 correspond to the protruding portions 500 of the connector 10. The second slots 24 correspond to the first hooks 240 of the connector 10. Specifically, the connector 10 is obliquely inserted into the first slot 22 with the protruding portions 500. The molding piece 100 can rotate relative to the frame 20 using the protruding portions 500 as a fulcrum. Please refer to the paragraphs below for detailed operation steps.

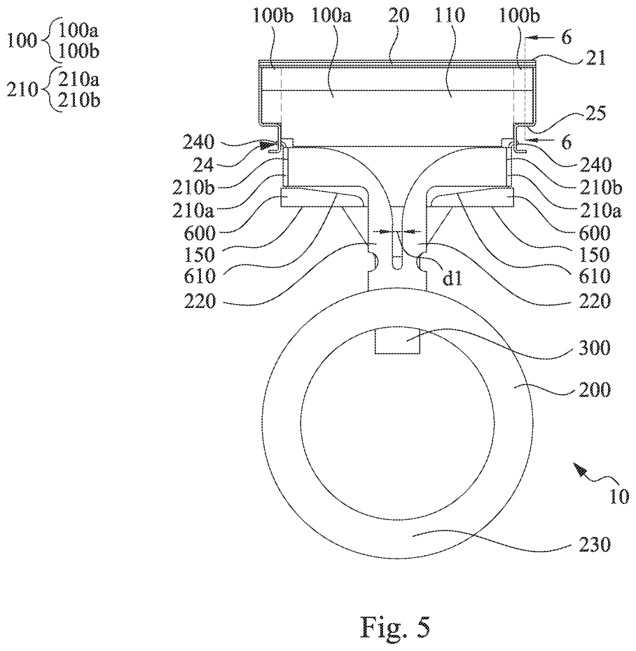

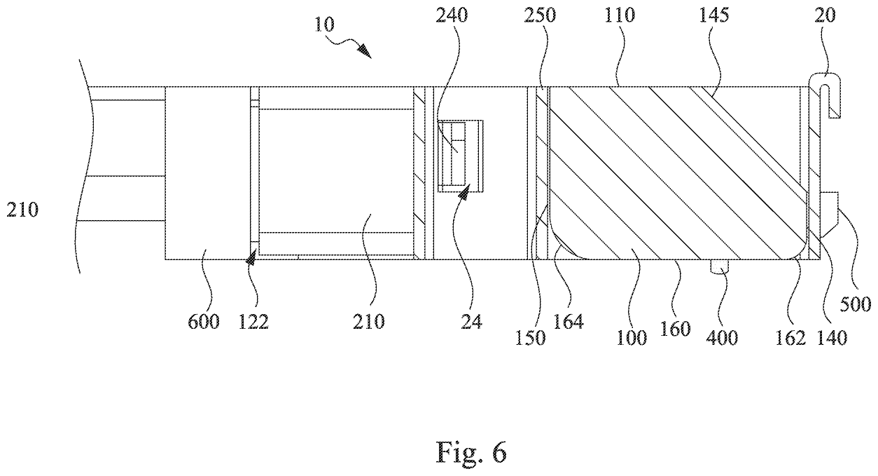

Reference is made to FIGS. 5 and 6. FIG. 5 is a top view of the connector 10 and the frame 20 according to an embodiment of the present disclosure. FIG. 6 is a cross-sectional view of the connector 10 and the frame 20 taken along line 6-6 in FIG. 5. In the present embodiments, the molding piece 100 further includes a first guiding arc surface 162 and a second guiding arc surface 164. Two ends of the first guiding arc surface 162 are respectively connected to the front surface 140 and the bottom surface 160. Two ends of the second guiding arc surface 164 are respectively connected to the bottom surface 160 and the rear surface 150. The first guiding arc surface 162 is located on a side of the molding piece 100 close to the protruding portions 500. The second guiding arc surface 164 is located on a side of the molding piece 100 away from the protruding portions 500. In other words, the second guiding arc surface 164 and the guiding inclined surface 145 are located on opposite sides of the molding piece 100.

As shown in FIGS. 5 and 6, in the present embodiments, the molding piece 100 includes a central portion 100a and two side portions 100b. The two side portions 100b are respectively connected to two sides of the central portion 100a. In other words, the two side portions 100b protrude from opposite sides of the central portion 100a away from of the barriers 600 in opposite directions. Each of the side portions 100b is configured to be disposed between the stopping wall 21 and a corresponding one of the protruding ribs 25. Specifically, the central portion 100a and the two side portions 100b include the first guiding arc surface 162. The two side portions 100b include the second guiding arc surface 164.

Reference is made to FIGS. 7 and 8. FIG. 7 is a side view of the connector 10, the frame 20, and a printed circuit board 30 during an installation process according to an embodiment of the present disclosure. FIG. 8 is a side view of the connector 10, the frame 20, and the printed circuit board 30 after installation according to an embodiment of the present disclosure. For clear explanation, the outline of the frame 20 in FIGS. 7 and 8 is drawn with dotted lines. The frame 20 and the printed circuit board 30 may be collectively referred to as a board-end connector, and the connector 10 may be referred to as a wire-end connector. The connector 10, the frame 20, and the printed circuit board 30 may be collectively referred to as an electrical connection module. In the present embodiment, the frame 20 is disposed on the printed circuit board 30. The protruding portions 500 insert into the first slots 22. Next, the molding piece 100 is configured to rotate relative to the printed circuit board 30 in the direction of arrow A with the protruding portions 500 as a fulcrum. It can be clearly observed that the guiding inclined surface 145 provides the effect of giving way and guiding. In other words, through the giving way and guiding of the guiding inclined surface 145, the connector 10 can be smoothly and obliquely inserted into the frame 20 and can rotate without interference. During the rotation process (i.e., the connector 10 rotates from the position in FIG. 7 to the position in FIG. 8), the first guiding arc surface 162 and the second guiding arc surface 164 can reduce collision and friction among the molding piece 100, the frame 20, and the printed circuit board 30. Especially the second guiding arc surface 164. During the rotation of the molding piece 100 relative to the printed circuit board 30, the second guiding arc surface 164 comes into contact with the protruding ribs 25. At this time, the second guiding arc surface 164 can better guide the moving direction of the molding piece 100 through a smooth arc, so that the plug terminals 400 can be smoothly inserted and electrically connected to the printed circuit board 30. When the plug terminals 400 are inserted into the printed circuit board 30, the first hooks 240 are configured to be engaged with the second slots 24 to fix the connector 10 relative to the printed circuit board 30.

In some embodiments, the guiding inclined surface 145 and the first guiding arc surface 162 are respectively located on opposite sides of the protruding portions 500. In this way, during the insertion and rotation process, the first guiding arc surface 162 can better reduce the collision and resistance generated between the protruding portions 500 and the frame 20.

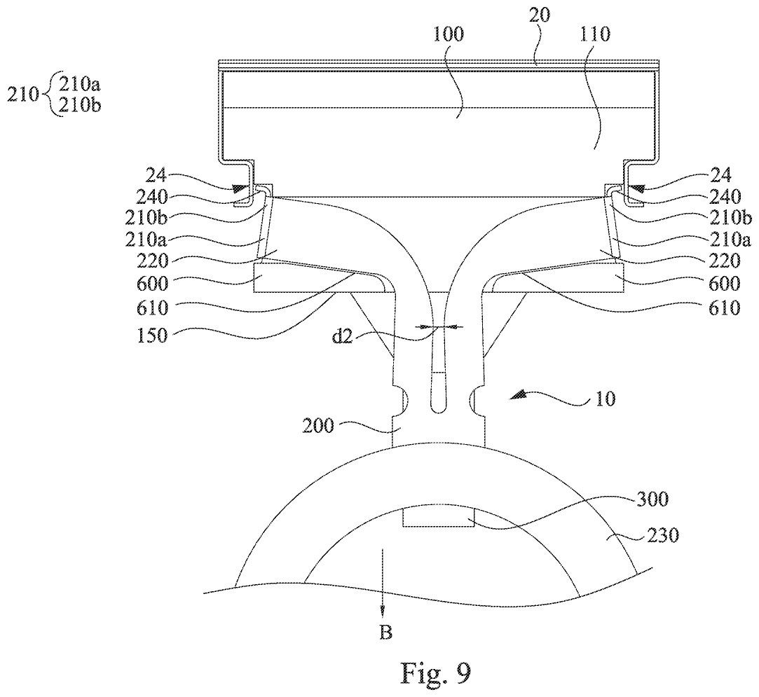

Reference is made to FIGS. 5 and 9. In the present embodiment, the connecting straps 220 are configured to be located at a locked state (as shown in FIG. 5) and an unlocked state (as shown in FIG. 9). When the connecting straps 220 are at the locked state, the first hooks 240 are engaged with the second slots 24 of the frame 20 to fix the connector 10 to the frame 20. When the connecting straps 220 are at the unlocked state, the first hooks 240 are separated from the second slots 24 so that the connector 10 can be separated from the frame 20.

The connecting straps 220 are configured to move back and forth between the locked state and the unlocked state relative to the molding piece 100. For example, when the pull handle 230 is forced along the pulling direction B, the connecting straps 220 at the locked state are forced to slide to the unlocked state along the upper surface 110 relative to the molding piece 100. The barriers 600 are disposed on a side of the molding piece 100 close to the pull handle 230. In other words, the barriers 600 are located on a side of the upper surface 110 close to the rear surface 150. The barriers 600 include first stopping surfaces 610. The connecting straps 220 face the first stopping surfaces 610. The first stopping surfaces 610 are located on a side of the barriers 600 away from the pull handle 230. When the connecting straps 220 are at the locked state, the connecting straps 220 are separated from the first stopping surfaces 610. When the connecting straps 220 are at the unlocked state, the connecting straps 220 abut against the first stopping surfaces 610. In other words, the first stopping surfaces 610 of the barriers 600 provide the functions of stopping and the limiting the connecting straps 220. In this way, the present disclosure provides a latch 200 that is simple in design and can correspond to various types of the molding pieces 100.

As shown in FIGS. 5 and 9, in the present embodiment, the snapping plates 210 have proximal end portions 210a and distal end portions 210b. The proximal end portions 210a can be defined as portions of the snapping plates 210 closer to the barriers 600. The proximal end portions 210a abut against the molding piece 100. The first hooks are connected to the distal end portions 210b. During movement of the connecting straps 220 of the latch 200 from the locked state to the unlocked state, the snapping plates 210 rotate relative to the molding piece 100 with the proximal end portions 210a as fulcrums, so that the first hooks 240 are close to the molding piece 100 to disengage from the second slots 24.

In some embodiments, the proximal end portions 210a abut against the barriers 600 when the connecting straps 220 of the latch 200 are at the locked state. The proximal end portions 210a are separated from the barriers 600 when the connecting straps 220 of the latch 200 are at the unlocked state.

In some embodiments, the connecting straps 220 are elastic hard plastic plates. In other words, when no force is applied, the connecting straps 220 can elastically recover to move to the locked state.

As shown in FIGS. 5 and 9, in the present embodiment, when the latch 200 is at the locked state, the gap 222 between adjacent sides of the two connecting straps 220 has a first distance d1. When the latch 200 is at the unlocked state, the gap 222 between adjacent sides of the two connecting straps 220 has a second distance d2. The first distance d1 is greater than the second distance d2. In this way, the latch 200 can be easily pulled through the deformation and movement of the connecting straps 220 to release the engagement of the first hooks 240.

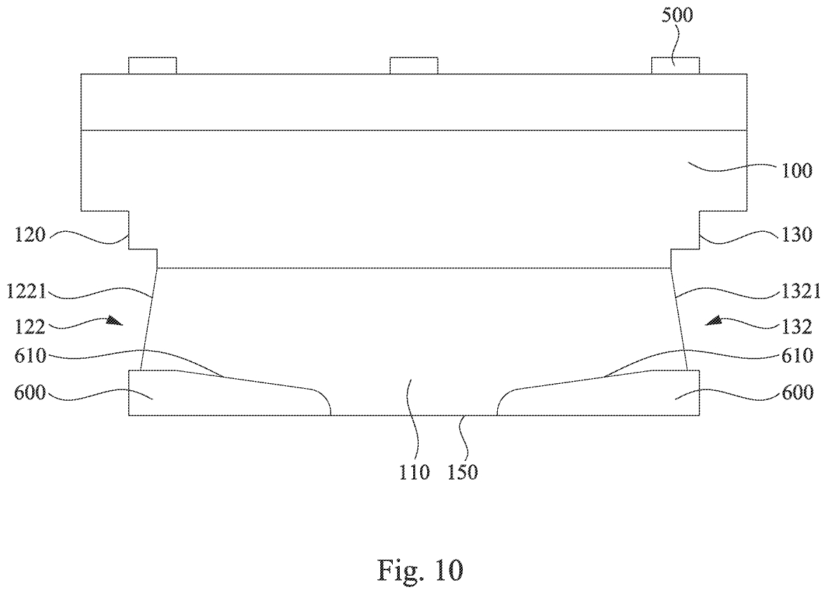

Reference is made to FIGS. 9 and 10. FIG. 10 is a top view of the molding piece 100 according to an embodiment of the present disclosure. In the present embodiment, the first stopping surfaces 610 are inclined surfaces. The first stopping surfaces 610 are closer to one of the two side surfaces 120, 130. The first stopping surfaces 610 gradually extend toward the rear surface 150 in a direction away from the one of the two side surfaces 120, 130. In other words, the first stopping surfaces 610 gradually extend toward the rear surface 150 in a direction away from the snapping plates 210. In some embodiments, the number of barriers 600 is two. The distance between the two first stopping surfaces 610 gradually decreases along the direction toward the pull handle 230.

As shown in FIGS. 9 and 10, in the present embodiment, the two positioning grooves 122, 132 respectively include second stopping surfaces 1221, 1321. When the latch 200 (the connecting straps 220) is at the locked state (referred to FIG. 5), the snapping plate 210 are separated from the second stopping surfaces 1221, 1321. When the latch 200 (the connecting straps 220) is at the unlocked state, the two snapping plate 210 respectively abut against the second stopping surfaces 1221, 1321.

As shown in FIG. 10, in the present embodiment, the two second stopping surfaces 1221, 1321 are inclined surfaces. The distance between the two second stopping surfaces 1221, 1321 gradually decreases in a direction away from the barriers 600.

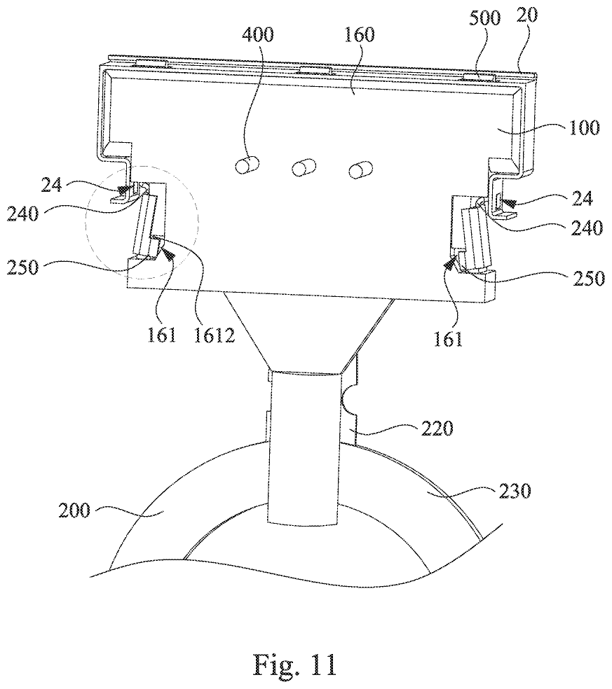

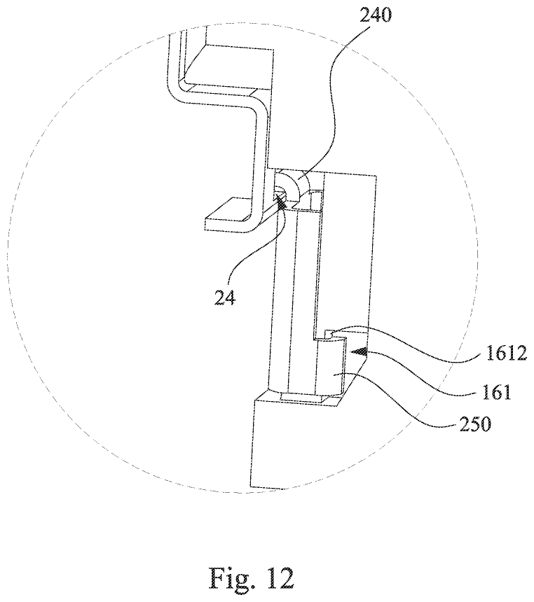

Reference is made to FIGS. 11 and 12. FIG. 11 is a bottom perspective view of the connector 10 and the frame 20 at the unlocked state according to an embodiment of the present disclosure. FIG. 12 is a partial enlarged view of the connector 10 and the frame 20 in the dotted circle in FIG. 11. In the present embodiment, the molding piece 100 includes recesses 161. The recesses 161 are located on the bottom surface 160. The second hooks 250 are configured to be engaged with the recesses 161, so that the latch 200 can be fixed on the molding piece 100. When the latch 200 moves between the locked state and the unlocked state relative to the molding piece 100, the second hooks 250 can move in the recesses 161. Specifically, when the latch 200 is at the locked state, the second hooks 250 abut against the sidewalls 1612 of the recesses 161. When the latch 200 is at the unlocked state, the second hooks 250 are at least partially disengaged from the sidewalls 1612 of the recesses 161.

According to the foregoing recitations of the embodiments of the disclosure, it can be seen that the connector provided in the present disclosure includes the barriers and the latch, which allows a user to easily pull the latch to unlock the connector. In addition, the latch of the present disclosure has a simple structure and low cost, and can be applied to various types of molding pieces. In other words, the present disclosure has the advantage of being easy to design.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector, comprising:
a base comprising a front surface, an upper surface, and two side surfaces;
two barriers connected to the upper surface, each of the barriers having a first stopping surface perpendicular to the upper surface; and
a latch comprising a pull handle connecting with two snapping plates via two connecting arms respectively, each of the snapping plates covering at least a portion of the two side surfaces of the base respectively, both of the snapping plates being substantially perpendicular to the connecting arms respectively, at least a portion of the connecting arms being located on the upper surface, at least one of the snapping plates having a first hook protruding away from the base,
wherein when the pull handle of the latch is pulled away from the base along a pulling direction, the latch switches from an unlocking state to a locking state, meanwhile, each of the connecting arms is moved and abuts against the stopping surface and control movement of the first hook via the at least one of the snapping plates.

2. The connector of claim 1, wherein when the latch switches from an unlocking state to a locking state, each of the connecting arms is deformed and abuts against the stopping surface.

3. The connector of claim 1, wherein both of the barriers are located on an edge of the front surface of the base and define a tunnel therebetween, and both of the connecting arms extend away from the base via the tunnel.

4. The connector of claim 1, wherein both of the connecting arms extend away from the base along the pulling direction via a tunnel formed between the two barriers.

5. The connector of claim 1, wherein each of the side surfaces of the base has a second stopping surface, when the latch is in a locked state, majority portions of the two snapping plates are separated from the two second stopping surfaces, and when the connecting arms are at the unlocked state, the majority portions the two snapping plates respectively abut against the two second stopping surfaces.

6. The connector of claim 5, wherein the two second stopping surfaces are inclined surfaces, and a distance between the two second stopping surfaces gradually changes in the pulling direction.

7. The connector of claim 1, wherein the base further comprises a rear surface connected to the upper surface, the barrier is located on a side of the upper surface close to the rear surface, the first stopping surface is an inclined surface, and the inclined surface gradually extends toward the rear surface along a direction away from the two snapping plates.

8. The connector of claim 1, wherein the one of the two snapping plates has a proximal end portion and a distal end portion, the first hook is connected to the distal end portion, wherein when the latch switches from the a locked state to the unlocked state, at least one of the two snapping plates rotates relative to the base with the proximal end portion as a fulcrum, so that the first hook is moved closer to the base.

9. The connector of claim 1, wherein the base further comprises a bottom surface opposite to the upper surface, the latch further comprises a second hook, the second hook is connected to at least one of the two snapping plates, and the second hook is engaged with a recess on the bottom surface for preventing the latch from separating from the base.

10. The connector of claim 1, wherein each of the connecting arms has a notch along an outer edge thereof.

11. The connector of claim 1, wherein the connecting arms and the snapping plates are one piece formed.

12. The connector of claim 1, wherein the base has an inserting section and a latching section, and all of the upper surface and the two side surfaces of the base are on a rear section side.

13. A connector, comprising:
a base comprising an upper surface and two positioning grooves, the two positioning grooves being respectively connected to opposite sides of the upper surface;
at least one barrier connected to the upper surface, wherein the at least one barrier has a first stopping surface;
a plugging terminal connected to the base;
a cable electrically connected to the plugging terminal in the base; and
a latch comprising a pull handle, two connecting straps, and two snapping plates, the two snapping plates being connected to the base and respectively disposed in the two positioning grooves, wherein the two connecting straps are respectively connected to the two snapping plates, and at least one of the two connecting straps faces the first stopping surface,
wherein the latch is configured to be located at a locked state and an unlocked state relative to the base, when the latch is at the locked state, a gap between the two connecting straps has a first distance, when the latch is at the unlocked state, the gap has a second distance, and the first distance is greater than the second distance.

14. The connector of claim 13, wherein one of the two connecting straps has a notch, and the notch is located on a side of the one of the two connecting straps away from another of the two connecting straps.

15. The connector of claim 13, wherein each of the two connecting straps has an arc edge, and the arc edges are located on adjacent sides of the two connecting straps.

16. The connector of claim 13, wherein a number of the at least one barrier is two, the two barriers respectively comprise two first stopping surfaces, and the two first stopping surfaces are located on a side of the barriers away from the pull handle and configured to be abutted by the connecting straps.

17. The connector of claim 16, wherein a distance between the two first stopping surfaces gradually decreases along a direction toward the pull handle.
